(19) United States
(12) Patent Application Publication
(10) Pub. No.: US 2011/0104332 A1
(43) Pub. Date: May 5, 2011

(54) METHOD FOR PRODUCING CHEESE

(75) Inventors: Johanna Bernardina Remmerswaal, Delft (NL); Albertus Alard Van Dijk, Vlaardingen (NL); Natalja Alekseevna Cyplenkova, Vlaardingen (NL)

(73) Assignee: DSM IP ASSETS B.V., Heerlen (NL)

(21) Appl. No.: 12/933,478

(22) PCT Filed: Mar. 18, 2009
(86) PCT No.: PCT/EP2009/053183

§ 371 Date: Sep. 20, 2010

(30) Foreign Application Priority Data
Mar. 20, 2008 (EP) 08102797.1

(51) Int. Cl. A23C 19/02; A23C 19/068

(52) U.S. Cl. 426/37; 426/36; 426/582

(57) ABSTRACT

A method of producing curd or cheese from a milk composition comprising the following steps: (1) heat-treating the milk composition; (2) treating the milk composition or a fraction thereof with a phospholipase; (3) adding protein hydrolysate, preferably yeast extract, to the heat-treated milk composition before or after the heat treatment; (4) coagulating the heat treated milk to form a gel; (5) processing the formed gel into a curd and separating the whey from the curd; and (6) optionally making cheese from the curd.

### FIELD OF THE INVENTION

The invention relates to a method of producing cheese.

### BACKGROUND OF THE INVENTION

Coagulation is an essential step in the traditional production of cheese from a dairy composition such as bovine milk. The coagulation may be started by acidification and/or the addition of an enzyme (coagulant) such as chymosine. After coagulation, the milk is separated into curd and whey. The curd is processed further into cheese. Caseins form the main protein component of the curd, and since cheese is a more valuable product than whey there is a desire to maximize the amount of protein incorporated into the curd. The inclusion of whey proteins into the curd would lead to an increase in cheese yield (=kg cheese produced from 1 L cheese milk), which is desirable. Alternatively, a more efficient incorporation of cheese fat in the curd would also result in an increase in cheese yield.

Cheese manufacturing processes from various milk sources have long been known and have been described in detail for many different types of cheese variants. (see e.g. Cheese: Chemistry, Physics and Microbiology, Vol 1 & 2, 1999, Ed. Fox, Aspen Publications, Gaithersburg, Md.; Encyclopedia of Dairy Sciences Vol 1-4, 2003, Academic Press, London). A crucial point in cheese manufacture is the process of coagulation, in which the solubility of the casein micelles and submicelles is decreased. Enzyme induced coagulation is very commonly used. Enzymes like calf chymosine, microbial equivalents of chymosine and other enzymes from other sources have been described and several are available under various trade names. All of them can be used to initiate the coagulation process. The primary step in coagulation is the cleavage of the Phe₁₀₅-Met₁₀₆ bond in κ-casein. This leads to removal of the C-terminal part of κ-casein: the glycomacropeptide (GMP). Removal of the GMP leads to association of the casein micelles, i.e casein coagulation. Casein coagulation leads to gel formation, and the time required to obtain gelling in a particular dairy composition is directly related to the activity of the coagulant.

The time that passes between addition of the coagulant and appearance of initial casein flocculation is defined as the coagulation time. The speed at which the gel is formed in cheese milk and the compactness of the gel depend closely on the quantity of enzyme added, the concentration of calcium ions, phosphorous, temperature and the pH. After the initial coagulation, a gel is formed and the consistency of the gel increases following an increase in the inter-micellar bonds. The micelles move together and the coagulum contracts, hereby expelling the whey. This phenomenon is known as syneresis and is accelerated by cutting the curd, increasing the temperature and increasing the acidity produced by the developing lactic acid bacteria.

For microbiological safety, cheese milk is heat treated prior to use. Various heat-treatments are used for milk such as thermisation (65° C., few seconds), low pasteurization (72° C., 15 seconds), high pasteurization (85° C., 20 seconds) and ultra high Temperature (UHT) treatment (e.g. 1 second, 145° C.). The heat treatment increases the keeping quality of milk and destroys micro-organisms. Furthermore, for certain dairy applications a particular heat treatment may be required to obtain the desired characteristics of the end product, such as in yogurt-making. Heat treatment may lead to impaired milk properties for cheese making purposes (see e.g. Singh & Waungana, Int Dairy J (2001), 11, 543-551). Heat treatments that lead to impaired milk clotting properties such as increased coagulation time, decreased curd firming rate or decreased curd strength will in the remainder of this text be referred to as ‘high heat treatment’; the resulting milk will be referred to as ‘high heated milk’ throughout this text.

Significant changes occurring upon heating milk above 60° C. include denaturation of whey proteins, interactions between denatured whey proteins and the casein micelles and the conversion of soluble calcium, magnesium and phosphate to the colloidal state. Casein micelles are very stable at high temperatures although changes in zeta-potential, size of hydration of micelles, as well as some association-dissociation reactions do occur at severe heating temperatures (Singh & Waungana, Int Dairy J (2001) 11, 543-551; and references cited therein). Upon heating milk above 65° C., whey proteins are denatured by the unfolding of their peptides. The unfolded proteins then interact with casein micelles or simply aggregate themselves, involving thiol-disulfide interchange reactions, hydrophobic interactions and ionic linkages. Ionic strength, pH and concentration of calcium and protein influence the extent of denaturation of the whey proteins. Heat denaturation of proteins is also influenced by lactose and other sugars, polyhydric alcohols and protein modifying agents.

Denatured whey proteins have been shown to associate with κ-casein on the surface of the casein micelles. The principle interaction is considered to be between β-lactoglobulin and κ-casein and involves both disulfide and hydrophobic interactions (Singh and Fox, J Dairy Res (1987) 54, 509-521). Part of the denatured whey proteins does not complex with the casein micelles, but form aggregates with other whey proteins. The extent of association of denatured whey proteins with casein micelles is markedly dependent on the pH of the milk prior to heating, levels of calcium and phosphate, milk solids concentration and type of heating system (water bath, indirect or direct). Indirect heating is reported to result in greater proportions of β-lactoglobulin and α-lactalbumin associating with the micelles compared to the situation where direct heating is used (e.g. steam injection). Heating at pH values less than 6.7 results in a greater quantity of denatured whey proteins associating with the micelles, whereas a higher pH values whey protein/κ-casein complexes dissociate from the micelle surface (Singh & Waunanga, Int Dairy J (2001) 11, 543-551).

Heat-treatment results in various changes in the milk. The most obvious change is the partial or full denaturation of whey proteins. The degree of denaturation depends on the heat treatment and the conditions in the milk such as pH and presence of additives like carbohydrates. Heat treatment of milk results in the formation of whey protein aggregates containing both α-lactalbumin and β-lactoglobulin (Singh & Waungana, Int Dairy J (2001), 11, 543-551; Vasbinder, Casein-whey protein interactions in heated milk, Thesis, ISBN 90-393-3194-4). The casein micelle fraction is not noticeably affected in the temperature range 70-100° C. Calcium phosphate, which is also present in the casein micelles, precipitates upon heat treatment and only slowly redissolves after cooling. Heat treatment of milk also results in the interaction of denatured whey proteins with the casein micelles. The interaction may be covalent via disulfide bond formation between e.g. β-lactoglubulin and κ-casein, and these interactions stabilize the casein micelle. The final composition of heat-treated milk depends on the milk pH and the temperature applied. The properties of the heated milk are determined by the final milk composition.

High heated milk shows impaired clotting behavior (Singh & Waungana (2001), Int Dairy J. 11, 543-551). Clotting times are increased and a weaker, finer curd is formed that retains more water than normal. In literature there is controversy about the cause of the increase in clotting time. A generally accepted explanation is that the κ-casein GMP moiety has reacted with β-lactoglobulin, and that this causes steric hindrance for the coagulating enzyme leading to inhibition of the κ-casein cleavage (see e.g. Singh et al (1988) J Dairy Res. 55, 205). The phenomenon of a weaker curd is explained in several ways. One explanation for the weaker curd is that the κ-casein is insufficiently cleaved (see: Walstra & Jennes, (1984) Dairy Chemistry and Physics, John Wiley and sons Inc, USA). Another explanation is that the heat-induced calcium phosphate precipitation is responsible (see e.g. Schreiber (2001) Int. Dairy J. 11, 553). A third explanation is that whey-proteins denature during heat treatment and associate with the casein micelles, thereby interfering with casein micelle-micelle interactions (Vasbinder, Casein-whey protein interactions in heated milk, Thesis, ISBN 90-393-3194-4). It is unclear which of these explanations is the most relevant.

It is known that the adverse effects of heat treatment on rennet coagulation can be overcome to some extent by either a) decreasing the pH to about 6.2, b) acidifying milk to below 5.5 followed by neutralization to 6.6 or c) adding calcium chloride (Lucey et al (1993) Cheese yield and factors affecting its control, special issue 9402 pp 448-456, International Dairy Federation). However, these remedies are not satisfactory solutions since the original curd strength and clotting time were not restored. Furthermore, extra handling of the cheese milk in case of pH adjustments is required. Recently, the use of protein hydrolysates was described as an alternative remedy to cure the poor clotting and curd forming properties of high heated milk (EP24557). This application describes a process in which high heated milk is used to prepare cheese; the protein hydrolysate is added after the heat treatment when the milk is cooled to cheese making temperatures, but prior to the addition of coagulant. It is demonstrated that the addition of the protein hydrolysate results in improved milk clotting and curd forming properties of the high heated milk.

The concepts described above aim to increase the amount of whey protein included in the cheese. This is accompanied by an increase in water content of the cheese because of the water binding capacity of the whey. As a result, the fat content of the final cheese is too low, which is undesired for traditional cheeses because of compositional demands and/or functional artifacts like melting characteristics for Mozzarella cheese. The same situation is encountered when extra milk proteins are in introduced into the cheese milk system to increase cheese yield. There is therefore a need to increase the milk fat content in cheese made with high-heat treated cheese milk that leads to a cheese with the desired protein, fat and water composition.

### SUMMARY OF THE INVENTION

The present invention relates to a method of producing curd or cheese from a milk composition comprising the following steps:
(1) heat-treating the milk composition;
(2) treating the milk composition or a fraction thereof with a phospholipase;
(3) adding protein hydrolysate, preferably yeast extract, to the heat-treated milk composition before or after the heat treatment;
(4) coagulating the heat treated milk to form a gel;
(5) processing the formed gel into a curd and separating the whey from the curd; and
(6) optionally making cheese from the curd.

According to the invention step (2) may also be performed before or after step (1) or (3) or during step (4) or (5).

It has surprisingly been found that the present process results in improved cheese yield caused by improved incorporation of milk protein and fat and a cheese with improved fat stability. The protein hydrolysate, preferably yeast extract, may be fortified by the addition of carboxylic acids such as malic acid, succinic acid, tartaric acid, adipic acid, citric acid or acetic acid, preferably malic acid. Preferably a dicarboxylic acid, preferably malic acid, is added to the protein hydrolysate in amount of 5-25% w/w, preferably 5-15% w/w, more preferably 7% w/w on dry matter based on hydrolysate.

Preferably the coagulation is an enzymatic coagulation. In a preferred embodiment the protein hydrolysate, preferably yeast extract, is added after the heat treatment.

The invention relates to a method of producing cheese, comprising treating the milk composition at an elevated temperature for a sufficient period of time, preferably to cause impaired milk clotting behavior during the coagulation step, cooling the milk to cheese making temperatures, adding to the milk a protein hydrolysate, preferably yeast extract, of 0.01-0.2% (w/v), preferably 0.05-0.1% (w/v) followed by addition of suitable starter culture and a coagulant to form a gel and processing the formed gel into a cheese curd and separating the whey from the curd. According to the present process a curd is obtained which comprises a protein hydrolysate, preferably yeast extract. The invention also describes the use of a yeast extract to reduce the clotting time in a cheese making process whereby heat treated milk is used, and the use of a protein hydrolysate, preferably yeast extract, to increase the curd strength of a curd in a cheese making process whereby heat treated milk is used.

According to the invention the protein hydrolysate, preferably yeast extract, can be added to the milk before or after the milk is heat treated. Benefits of the protein hydrolysate, preferably yeast extract, addition are for example the elimination of the increase in milk clotting time and reduction or elimination of the increased curd weakness that would normally occur and finally also the amount of required starter culture for the cheese making can be reduced. Preferably the protein hydrolysate, preferably yeast extract, is added after the heat treatment.

In this text the terms ‘dairy composition’ and ‘milk’ will both be used; milk is considered as an example of a dairy composition herein.

Another aspect of the invention relates to a method of producing cheese, comprising treating the cheese milk by high heat treatment, treating the milk composition or a fraction thereof with a phospholipase, adding to the cheese milk a protein hydrolysate, preferably yeast extract, and producing cheese from said dairy composition.

A further aspect of the invention relates to the cheese produced by the methods of the invention.

### DETAILED DESCRIPTION OF THE INVENTION

We have surprisingly found that the addition of a yeast hydrolysate to high heated milk, combined with the use of a phospholipase, results in an increase in cheese yield caused by increased levels of protein, milk fat and water.

In the present context, the term “cheese” refers to any kind of cheese such as e.g. natural cheese, cheese analogues and processed cheese. The cheese may be obtained by any suitable process known in the art such as e.g. by enzymatic coagulation of a dairy composition with rennet, or by acidic coagulation of a dairy composition with a food grade acid or acid produced by lactic acid bacteria growth. In one embodiment, the cheese manufactured by the process of the invention is rennet-curd cheese. The dairy composition may be subjected to a conventional cheese-making process.

Processed cheese is preferably manufactured from natural cheese or cheese analogues by cooking and emulsifying the cheese, such as with emulsifying salts (e.g. phosphates and citrate). The process may further include the addition of spices/condiments.

The term “cheese analogues” refers to cheese-like products which contain fat (such as e.g. milk fat (e.g. cream) as part of the composition, and which further contain, as part of the composition, a non-milk constituent, such as e.g. vegetable oil.

The cheese produced by the process of the present invention comprises all varieties of cheese, such as soft cheese, semi-hard cheese and hard cheese. In cheese manufacture, the coagulation of a dairy composition is preferably performed either by rennet or by acidification alone resulting in rennet-curd and acid-curd cheese, respectively. Fresh acid-curd cheeses refer to those varieties of cheese produced by the coagulation of milk, cream or whey via acidification or a combination of acid and heat, and which are ready for consumption once the manufacturing without ripening is completed. Fresh acid-curd cheeses generally differ from rennet-curd cheese varieties (e.g. Camembert, Cheddar, Emmenthal) where coagulation normally is induced by the action of rennet at pH values 6.4-6.6, in that coagulation normally occurs close to the iso-electric point of casein, i.e. e.g. at pH4.6 or at higher values when elevated temperatures are used, e.g. in Ricotta at pH typically about 6.0 and temperature typically about 80° C. In a preferred embodiment of the invention, the cheese belongs to the class of rennet curd cheeses.

Mozzarella is a member of the so-called pasta filata, or stretched curd, cheese which are normally distinguished by a unique plasticizing and kneading treatment of the fresh curd in hot water, which imparts the finished cheese its characteristic fibrous structure and melting and stretching properties. In one embodiment the invention further comprises a heat-stretching treatment as for pasta filata cheeses, such as for the manufacturing of Mozzarella.

### Relevance of the Rate of Acidification

In the initial phase of cheese making, acidification takes place. This is usually achieved through in situ production of lactic acid through fermentation of lactose by lactic acid bacteria (LAB). Direct acidification using acid (e.g. lactic acid or citric acid) is an alternative to biological acidification and is used commercially to a significant extent in the manufacture of cottage, quark, Mozzarella and feta-type cheese. Direct acidification is more controllable than biological acidification. The rate of acidification depends on the amount and type of starter added and on the temperature profile of the curd (Encyclopedia of dairy sciences, 2003, p 256-257. Ed: Roginski et al, Academic Press). The ultimate pH of most rennet-coagulated cheeses os 5.0-5.3, but the pH of acid-coagulated varieties, e.g. cottage, quark, cream and some soft rennet-coagulated varieties e.g. Camembert and Brie is at ˜4.6. The production of acid at the appropriate rate and time affects several aspects of cheese manufacture and is critical for the production of good quality cheese (Encyclopedia of dairy sciences, 2003, p 256-257. Ed: Roginski et al, Academic Press). Aspects that are affected by the acidification rate are:
coagulant activity during coagulation
denaturation and retention of coagulant in the curd
gel strength, which influences cheese yield
gel syneresis, which controls the moisture content of cheese and hence regulates the growth of bacteria and the activity of enzymes in the cheese;
colloidal calcium phosphate dissolves as the pH decreases
acidification controls the growth of many non-starter bacteria in cheese
   The Encyclopedia of dairy sciences, (2003, p 256 and further, Ed: Roginski et al, Academic Press) describes in detail relevance of various aspects of cheese making.

### Dairy Composition

“Dairy composition” or “milk composition” or “cheese milk”, which terms are used interchangeably, may be any composition comprising cows milk constituents but which comprises at least casein and whey. Milk constituents may be any constituent of milk such as milk fat, milk protein, casein, whey protein and lactose. A milk fraction may be any fraction of milk such as e.g. skim milk, butter milk, whey, cream, milk powder, whole milk powder, skim milk powder. In a preferred embodiment of the invention the dairy composition comprises milk, skim milk, butter milk, whole milk, whey, cream, or any combination thereof. In a more preferred embodiment the dairy composition consists of milk, such as skim milk, whole milk, cream or any combination thereof.

In further embodiments of the invention, the dairy composition is prepared, totally or in part, from dried milk fractions, such as e.g. whole milk powder, skim milk powder, casein, caseinate, total milk protein or buttermilk powder, or any combination thereof.

According to the invention the dairy composition comprises cow's milk and or one or more cow's milk fractions. The cow's milk fractions may be from any breed of cow (Bos Taurus (Bos taurus taurus), Bos indicus (Bos indicus taurus) and crossbreeds of these. In one embodiment the dairy composition comprises cow's milk and/or cow's milk fractions originating from two or more breeds of cows. The dairy composition also comprises milk from other mammals that are used for cheese preparation, such as milk derived from goat, buffalo or camel.

The dairy composition for production of cheese may be standardized to the desired composition by removal of all or a portion of any of the raw milk components and/or by adding thereto additional amounts of such components. This may be done e.g. by separation of milk into cream and milk upon arrival to the dairy. Thus, the dairy composition may be prepared as done conventionally by fractionating milk and recombining the fractions so as to obtain the desired final composition of the dairy composition. The separation may be made in continuous centrifuges leading to a skim milk fraction with very low fat content (i.e. <0.5%) and cream with e.g. >35% fat. The dairy composition may be prepared by mixing cream and skim milk. In another embodiment the protein and/or casein content may be standardized by the use of ultra filtration. The dairy composition may have any total fat content that is found suitable for the cheese to be produced by the process of the invention.

In one embodiment of the invention, calcium is added to the dairy composition. Calcium may be added to the dairy composition at any appropriate step before and/or during cheese making, such as before, simultaneously with, or after addition of starter culture. In a preferred embodiment calcium is added both before and after the heat treatment. Calcium may be added in any suitable form. In a preferred embodiment calcium is added as calcium salt, e.g. as CaCl₂. Any suitable amount of calcium may be added to the dairy composition. The concentration of the added calcium will usually be in the range 0.1-5.0 mM, such as between 1 and 3 mM. If CaCl₂ is added to the dairy composition the amount will usually be in the range 1-50 g per 100 liter of dairy composition, such as in the range 5-30 g per 1000 liter dairy composition, preferably in the range 10-20 g per 100 liter dairy composition.

The bacterial count of skim milk may be lowered by conventional steps. In an embodiment of the invention, the dairy composition may be subjected to a homogenization process before production of cheese, such as in the production of Danish Blue Cheese.

A “dairy product” is a product that comprises curd or cheese or comprises processed curd or cheese.

### Heat Treatment

It is well known that heat treatment of milk during commercial processing operations results in a number of physicochemical changes in the milk constituents. The type of changes and extent of these changes are determined by temperature of the treatment, the time of the heat treatment and the composition of the milk such as its pH, concentration of protein and fat and presence of cat ions like e.g. calcium and magnesium. Sometimes, a different combination of parameters can lead to the same or similar end result. For example, a short heat treatment at high temperature may have similar effects as a longer heat treatment at low temperature. It is known to the expert in the field how experimental parameters should to be changed to obtain similar end results for different processing routes, or how such routes should be established.

According to the invention the dairy composition is heat treated at an elevated temperature for a time that is preferably sufficient to cause impaired milk coagulation in the coagulation step. By impaired milk coagulation in cheese making is meant that the coagulation time is increased compared to the coagulation time in cheese making using non-heated milk. Preferably, the coagulation time is increased with 10% or more compared to the coagulation time in cheese making using non-heated milk. In addition the resulting curd is weaker compared to the curd prepared from milk with a regular heating process like pasteurization. The heat treatment may be performed at a temperature of at least 75° C., preferably at least 80° C. In one embodiment the heat treatment is conducted at a temperature between 75° C. and 145° C., in a preferred embodiment the heat treatment is conducted at a temperature between 75° C. and 120° C., in a more preferred embodiment the heat treatment is conducted at a temperature between 75° C. and 100° C., in an even more preferred embodiment the heat treatment is performed between 80° C. and 90° C. The duration of the heat treatment may be any time suitable to achieve impaired milk clotting behaviour. In one embodiment the duration of the heat treatment is between 1 second and 30 minutes. In one embodiment the heat treatment is conducted at 75° C. to 90° C. degrees for 5 seconds to 30 minutes, in another embodiment the heat treatment is conducted at 80° C. to 90° C. for 2 seconds to 30 minutes, in a still further embodiment the heat treatment is conducted at 80° C. to 145° C. from 1 second to 20 minutes. The heat treatment may be conducted by any method known in the art, such as e.g. in a plate heat exchanger, by batch wise heating of the milk in a tank or container or by steam injection. Heat treatment of whey proteins, either separately, in mixture or in milk, is a well known phenomenon and has been described in literature (e.g. Mulvihill & Donovan (1987) Ir. J. Food Sci. Techn. 11, 43-75). The quantification of whey protein denaturation can be measured by determining the loss of solubility in the isoelectric pH range or on saturation with NaCl. Another manifestation of whey protein denaturation is the increased side group reactivity, especially the sulphydryl-groups of β-lactoglobulin (Mulvihill & Donovan (1987) Ir. J. Food Sci. Techn. 11, 43-75 and references sited therein). Milk pasteurization before cheese making, results in very limited whey protein denaturation, preferably less than 20% and preferably less than 10% of whey protein is denaturated. When heat treatment is more severe, the degree of denaturation will increase, as described in literature (e.g. Law & Leaver (1997) J Agric Food Chem 45, 4255-4261; Law & Leaver (2000) J Agric Food Chem 48, 672-679). In contrast to pasteurization, the heat treatment of the present invention, high heat treatment of milk, will result in a much higher degree of whey denaturation of at least 30%, or for at least 40%, or for at least 50%, or for at least 60% or for at least 70% or even for at least 80%.

The effect of heat treatment is very sensitive to the time of heating and the exact temperature. Slight variations in heating time result in variation of the properties of the heated milk. In an industrial environment, heating processes are very well controlled and standardized. Laboratory processes are more difficult to control, and small variations of e.g. the heating time may result in slight alterations of the properties of the heated milk. This results in differences of 10-20% between individual heated milk batches, depending on the property that is measured.

### Yeast Extracts

In the present text yeast extract or yeast hydrolysate (both terms are synonyms in the present text) is seen as an example of a protein hydrolysate.

“Yeast extracts” can be divided into two main groups, based on their method of preparation: autolytic yeast extracts and hydrolytic yeast extracts. “Autolytic yeast extracts” are concentrates of the soluble materials obtained from yeast after disruption of the cells and digestion (lysis) of the polymeric yeast material. The active yeast enzymes released in the medium after cell disruption are responsible for the lysis. Generally these types of yeast extracts do not comprise 5′-ribonucleotides because during the autolytic process the native RNA is decomposed or modified in a form which is not or almost not degradable into 5′-ribonucleotides. These types of yeast extract, which are rich in amino acids, are used in the food industry as basic taste providers. The amino acids present in the yeast extract add a bouillon-like, brothy taste to the food. “Hydrolytic yeast extracts”, on the other hand, are concentrates of the soluble materials obtained from yeast after disruption of the cells, digestion (lysis) and addition of proteases and/or peptidases and especially nucleases to the yeast suspension during lysis. The native yeast enzymes are inactivated prior to the lysis. During this process, 5′-ribonucleotides of guanine (5′-guanine mono phosphate; 5′-GMP), uracil (5′-uracil mono phosphate; 5′-UMP), cytosine (5′-cytosine mono phosphate; 5′-CMP) and adenine (5′-adenine mono phosphate; 5′-AMP) are formed. When adenylic deaminase is added to the mixture, 5′-AMP is transformed into 5′-inosine mono phosphate (5′-IMP). The hydrolytic yeast extracts obtained by this method are therefore rich in 5′-ribonucleotides, especially rich in 5′-GMP and 5′-IMP. Often yeast extracts are also rich in mono sodium glutamate (MSG).5′-IMP, 5′-GMP and MSG are known for their flavour enhancing properties. They are capable of enhancing the savoury and delicious taste in certain types of food. This phenomenon is described as ‘mouthfeel’ or umami. Yeast extracts rich in 5′-ribonucleotides and, optionally, rich in MSG, are usually added to soups, sauces, marinades and flavour seasonings.

Yeast extract according to this invention may be added as liquid formulation, as paste, granulate or powder.

### Protein Hydrolysates

Protein hydrolysates or hydrolyzed proteins can be prepared by incubating a protein source with a single protease or a combination of proteases. Such proteases may be any type of protease including but not limited to endo-proteases, amino peptidases, carboxypeptidases or di- and tri-aminopeptidases. Also hydrolysates produced without enzymes of partly enzymatically produced are part of the present invention, for example hydrolysates can be produced using acids or a combination of acidic treatment and enzymatic treatment. Yeast extracts can be considered to be a crude protein hydrolysate.

The protein source can in principle be any protein source. A preferred source is whey protein, casein protein or a mixture thereof, more preferably whey protein. A composition comprising whey protein according to the invention may be any composition comprising whey protein such as milk, cream and cheese whey. Whey derived from any cheese source may be used, including cheddar cheese, Swiss cheese, mozzarella cheese and the like. A composition comprising whey protein may be any aqueous solution comprising whey protein. The whey protein may be obtained by any method known in the art. Whey protein preparations are commercially available in several forms such as whey protein concentrates (WPC) and whey protein isolates (WPI). Suitable protein substrates for hydrolysis also include whole milk, skimmed milk, acid casein, rennet casein, acid whey products or cheese whey products. Moreover, vegetable substrates like wheat gluten, milled barley and protein fractions obtained from, for example, soy, rice or corn are suitable substrates.

Protein hydrolysates can be prepared by contacting the protein substrate with one proteolytic enzyme or a combination of proteolytic enzymes. Preferably at least one endoprotease, more preferably at least two or more endoproteases are used. Particularly suited are the broad spectrum endo-proteases such as Alcalase and Collupuline. By broad spectrum endoprotease is meant an endoprotease which has at least three preferential cleavage sites. Examples are papain, subtilisin, pancreatine, alkaline serine protease (e.g. esperase). Also a complex enzyme mixture especially an endoprotease containing mixture can be used such as an Aspergillus orzae or an Aspergillus niger derived preparation. In case more than one protease is used, these proteases can be added to the protein substrate simultaneously. Alternatively, the proteases can be added to the protein in a predefined sequence. Optionally, the addition of the next protease is preceded by an inactivation of the protease pr proteases that were used earlier in the hydrolysis process. Such inactivation may be achieved in various ways and the method of choice depends on the protease that has to be inactivated. Inactivation treatments include but are not limited to heat treatment and a change in pH. Alternatively, commercially available hydrolysates can be used.

The degree of hydrolysis (DH) of a protein substrate is an important parameter. The DH that can be achieved for protein hydrolysate and depends on a large number of parameters, which include but are not limited to the choice for a particular protease, the time that is allowed for the hydrolysis to proceed, the reaction conditions (pH, temperature, salt concentration etc) and the pre-treatment of the protein substrate before it is subjected to hydrolysis by the protease. The DH of the hydrolysate suitable for the process according to the invention may range form 5-50, preferably from 10-40, more preferably form 15-35. The hydrolysate may contain free amino acids. Methods to determine the DH are known to the experts in the field, e.g. the OPA-method described by Church et al (Anal Biochem (1985) 146, 343).

The hydrolysates can be further processed in various ways, methods including but not limited to spray drying, ultrafiltration, freeze drying, vacuum drying. After drying, the dry material may be grinded and/or sieved in order to obtain fractions of a particular particle size range. Alternatively, protein hydrolysate may be used as liquid formulation, as paste or as granulate. Compounds may be added to the hydrolysate to facilitate drying or to influence the final characteristics of the dried hydrolysate such as its tendency to form lumps or its wettability.

### Fortification

For the purpose of this invention protein hydrolysate, preferably yeast extract, may be fortified with carboxylic acids, such as malic acid, succinic acid, tartaric acid, adipic acid, citric acid or acetic acid, preferably malic acid. Addition of carboxylic acid may be done before or after drying of the yeast extract or hydrolysate, preferably before drying the protein hydrolysate, preferably yeast extract,. The carboxylic acids may also be added to re-dissolved protein hydrolysate, preferably yeast extract, after which the protein hydrolysate, preferably yeast extract, may optionally be dried again using methods known in the art such as spray drying and freeze drying. The carboxylic acids may also be added separately from the protein hydrolysate, preferably yeast extract, to the process of the invention or together with protein hydrolysate, preferably yeast extract, to the process of the invention. The carboxylic acid may be added as the free acid or in the form of a salt of the acid, such as the ammonium salt. The addition of the carboxylic acid enhances the beneficial effects of the protein hydrolysate, preferably yeast extract, in curing the poor renneting properties of high heated milk. The carboxylic acids may be added to the protein hydrolysate, preferably yeast extract, at 1-10% (w/w) of dry matter, preferably 5-10% (w/w), more preferably 7-9% (w/w).

### Proteolytic Enzymes

Proteins can be regarded hetero-polymers that consist of amino acid building blocks connected by a peptide bond. The repetitive unit in proteins is the central alpha carbon atom with an amino group and a carboxyl group. Except for glycine, a so-called amino acid side chain substitutes one of the two remaining alpha carbon hydrogen atoms. The amino acid side chain renders the central alpha carbon asymmetric. In general, in proteins the L-enantiomer of the amino acid is found. The following terms describe the various types of polymerized amino acids. Peptides are short chains of amino acid residues with defined sequence. Although there is not really a maximum to the number of residues, the term usually indicates a chain which properties are mainly determined by its amino acid composition and which does not have a fixed three-dimensional conformation. The term polypeptide is usually used for the longer chains, usually of defined sequence and length and in principle of the appropriate length to fold into a three-dimensional structure. Protein is reserved for polypeptides that occur naturally and exhibit a defined three-dimensional structure. In case the proteins main function is to catalyze a chemical reaction it usually is called an enzyme. Proteases are the enzymes that catalyze the hydrolysis of the peptide bond in (poly)peptides and proteins.

Under physiological conditions proteases catalyse the hydrolysis of the peptide bond. The International Union of Biochemistry and Molecular Biology (1984) has recommended to use the term peptidase for the subset of peptide bond hydrolases (Subclass E.C 3.4.). The terms protease and peptide hydrolase are synonymous with peptidase and may also be used here. Proteases comprise two classes of enzymes: the endo-peptidases and the exo-peptidases, which cleave peptide bonds at points within the protein and remove amino acids sequentially from either N or C-terminus respectively. Proteinase is used as a synonym for endo-peptidase. The peptide bond may occur in the context of di-, tri-, tetra-peptides, peptides, polypeptides or proteins. In general the amino acid composition of natural peptides and polypeptides comprises 20 different amino acids, which exhibit the L-configuration (except for glycine which does not have a chiral centre). However the proteolytic activity of proteases is not limited to peptides that contain only the 20 natural amino acids. Peptide bonds between so-called non-natural amino acids can be cleaved too, as well as peptide bonds between modified amino acids or amino acid analogues. Some proteases do accept D enantiomers of amino acids at certain positions. In general the remarkable stereo-selectivity of proteases makes them very useful in the process of chemical resolution. Many proteases exhibit interesting side activities such as esterase activity, thiol esterase activity and (de)amidase activity. These side activities are usually not limited to amino acids only and might turn out to be very useful in bioconversions in the area of fine chemicals.

Eukaryotic microbial proteases have been reviewed by North (1982). More recently, Suarez Rendueles and Wolf (1988) have reviewed the S. cerevisiae proteases and their function.

Apart from the hydrolytic cleavage of bonds, proteases may also be applied in the formation of bonds. Bonds in this aspect comprise not only peptide and amide bonds but also ester bonds. Whether protease catalyses the cleavage or the formation of a particular bond does in the first place depend on the thermodynamics of the reaction. An enzyme such as a protease does not affect the equilibrium of the reaction. The equilibrium is dependent on the particular conditions under which the reaction occurs. Under physiological conditions the thermodynamics of the reactions is in favour of the hydrolysis of the peptide due to the thermodynamically very stable structure of the zwitterionic product. By application of physical-chemical principles to influence the equilibrium or by manipulating the concentrations or the nature of the reactants and products, or by exploiting the kinetic parameters of the enzyme reaction it is possible to apply proteases for the purpose of synthesis of peptide bonds. The addition of water miscible organic solvents decreases the extent of ionisation of the carboxyl component, thereby increasing the concentration of substrate available for the reaction. Biphasic systems, water mimetics, reverse micelles, anhydrous media, or modified amino and carboxyl groups to invoke precipitation of products are often employed to improve yields. When the proteases with the right properties are available the application of proteases for synthesis offers substantial advantages. As proteases are stereo-selective as well as region-selective, sensitive groups on the reactants do usually not need protection and reactants do not need to be optically pure. As conditions of enzymatic synthesis are mild, racemisation and decomposition of labile reactants or products can be prevented. Apart from bonds between amino acids, also other compounds exhibiting a primary amino group, a thiol group or a carboxyl group may be linked by properly selected proteases. In addition esters, thiol esters and amides may be synthesized by certain proteases. Protease has been shown to exhibit region-selectively in the acylation of mono, di- and tri-saccharides, nucleosides, and riboflavin. Problems with stability under the sometimes harsh reaction conditions may be prevented by proper formulation. Encapsulation and immobilisation do not only stabilise enzymes but also allow easy recovery and separation from the reaction medium. Extensive crosslinking, treatment with aldehydes or covering the surface with certain polymers such as dextrans, polyethyleneglycol, polyimines may substantially extend the lifetime of the biocatalyst.

The selectivity of limited proteolysis appears to reside more directly in the proteinase-substrate interaction. Specificity may be derived from the proteolytic enzyme which recognizes only specific amino acid target sequences. On the other hand, it may also be the result of selective exposure of the ‘processing site’ under certain conditions such as pH, ionic strength or secondary modifications, thus allowing an otherwise non-specific protease to catalyze a highly specific event. The activation of vacuolar zymogens by limited proteolysis gives an example of the latter kind.

Four major classes of proteases are known and are designated by the principal functional groups in their active site: the ‘serine’, the ‘thiol’ or ‘cysteine’, the ‘aspartic’ or ‘carboxyl’ and the ‘metallo’ proteases. A detailed state of the art review on these major classes of proteases, minor classes and unclassified proteases can be found in Methods in Enzymology part 244 and 248 (A. J. Barrett ed, 1994 and 1995).

Apart from the catalytic machinery of proteases another important aspect of proteolytic enzymes is the specificity of proteases. The specificity of a protease indicates which substrates the protease is likely to hydrolyze. The twenty natural amino acids offer a large number of possibilities to make up peptides. E.g. with twenty amino acids one can make up already 400 dipeptides and 8000 different tripeptides, and so on. With longer peptides the number of possibilities will become almost unlimited. Certain proteases hydrolyze only particular sequences at a very specific position. The interaction of the protease with the peptide substrate may encompass one up to ten amino acid residues of the peptide substrate. With large proteinacious substrates there may be even more residues of the substrate that interact with the proteases. However this likely involves less specific interactions with protease residues outside the active site binding cleft. In general the specific recognition is restricted to the linear peptide, which is bound in the active site of the protease.

The nomenclature to describe the interaction of a substrate with a protease has been introduced in 1967 by Schechter and Berger (Biochem. Biophys. Res. Com., 1967, 27, 157-162) and is now widely used in the literature. In this system, it is considered that the amino acid residues of the polypeptide substrate bind to so-called sub-sites in the active site. By convention, these sub-sites on the protease are called S (for sub-sites) and the corresponding amino acid residues are called P (for peptide). The amino acid residues of the N-terminal side of the scissile bond are numbered P3, P2, P1 and those residues of the C-terminal side are numbered P1′, P2′, P3′. The P1 or P1′ residues are the amino acid residues located near the scissile bond. The substrate residues around the cleavage site can then be numbered up to P8. The corresponding sub-sites on the protease that complement the substrate binding residues are numbered S3, S2, S1, S1′, S2′, S3′, etc, etc. The preferences of the sub-sites in the peptide binding site determine the preference of the protease for cleaving certain specific amino acid sequences at a particular spot. The amino acid sequence of the substrate should conform with the preferences exhibited by the sub-sites. The specificity towards a certain substrate is clearly dependant both on the binding affinity for the substrate and on the velocity at which subsequently the scissile bond is hydrolysed. Therefore the specificity of a protease for a certain substrate is usually indicated by its kcat/Km ratio, better known as the specificity constant. In this specificity constant kcat represents the turn-over rate and Km is the dissociation constant.

Apart from amino acid residues involved in catalysis and binding, proteases contain many other essential amino acid residues. Some residues are critical in folding, some residues maintain the overall three dimensional architecture of the protease, some residues may be involved in regulation of the proteolytic activity and some residue may target the protease for a particular location. Many proteases contain outside the active site one or more binding sites for metal ions. These metal ions often play a role in stabilizing the structure. In addition secreted eukaryotic microbial proteases may be extensively glycosylated. Both N- and O -linked glycosylation occurs. Glycosylation may aid protein folding, may increase solubility, prevent aggregation and as such stabilize the mature protein. In addition the extent of glycosylation may influence secretion as well as water binding by the protein.

In principle the modular organization of larger proteins is a general theme in nature. In particular within the larger multimodular frameworks typical proteolytic modules show sizes of 100 to 400 amino acids on the average. This corresponds with the average size of most of the globular proteolytic enzymes that are secreted into the medium. As discussed above polypeptide modules are polypeptide fragments, which can fold and function as independent entities. Another term for such modules is domains. However domain is used in a broader context than module. The term domain as used herein refers usually to a part of the polypeptide chain that depicts in the three-dimensional structure a typical folding topology. In a protein domains interact to varying extents, but less extensively than do the structural elements within domains. Other terms such as subdomain and folding unit are also used in literature. As such it is observed that many proteins that share a particular functionality may share the same domains. Such domains can be recognized from the primary structure that may show certain sequence patterns, which are typical for a particular domain. Typical examples are the mononucleotide binding fold, cellulose binding domains, helix-turn-helix DNA binding motif, zinc fingers, EF hands, membrane anchors. Modules refer to those domains which are expected to be able to fold and function autonomously. A person skilled in the art knows how to identify particular domains in a primary structure by applying commonly available computer software to said structure and homologous sequences from other organisms or species.

Although multimodular or multidomain proteins may appear as a string of beads, assemblies of substantial more complex architecture have been observed. In case the various beads reside on the same polypeptide chain the beads are generally called modules or domains. When the beads do not reside on one and same polypeptide chain but form assemblies via non-covalent interactions then the term subunit is used to designate the bead. Subunits may be transcribed by one and the same gene or by different genes. The multi-modular protein may become proteolytically processed after transcription leading to multiple subunits. Individual subunits may consist of multiple domains. Typically the smaller globular proteins of 100-300 amino acids usually consist only of one domain.

In general proteases are classified according to their molecular properties or according to their functional properties. The molecular classification is based on the primary structure of the protease. The primary structure of a protein represents its amino acid sequence, which can be derived from the nucleotide sequence of the corresponding gene. Tracing extensively the similarities in the primary structures may allow for the notice of similarities in catalytic mechanism and other properties, which even may extend to functional properties. The term family is used to describe a group of proteases that show evolutionary relationship based on similarity between their primary structures. The members of such a family are believed to have arisen by divergent evolution from the same ancestor. Within a family further sub-grouping of the primary structures based on more detailed refinement of sequence comparisons results in subfamilies. Classification according to three-dimensional fold of the proteases may comprise secondary structure, tertiary structure and quarternary structure. In general the classification on secondary structure is limited to content and gross orientation of secondary structure elements. Similarities in tertiary structure have led to the recognition of superfamilies or clans. A superfamily or a clan is a group of families that are thought to have common ancestry as they show a common 3-dimensional fold. In general tertiary structure is more conserved than the primary structure. As a consequence similarity of the primary structure does not always reflect similar functional properties. In fact functional properties may have diverged substantially resulting in interesting new properties. At present quarternary structure has not been applied to classify various proteases. This might be due to a certain bias of the structural databases towards simple globular proteases. Many proteolytic systems that are subject to activation, regulation, or complex reaction cascades are likely to consist of multiple domains or subunits. General themes in the structural organization of such protease systems may lead to new types of classification.

In absence of sequence information proteases haven been subject to various type of functional classification. The classification and naming of enzymes by reference to the reactions which are catalyzed is a general principle in enzyme nomenclature. This approach is also the underlying principle of the EC numbering of enzymes (Enzyme Nomenclature 1992 Academic Press, Orlando). Two types of proteases (EC 3.4) can be recognized within Enzyme Nomenclature 1992, those of the exo-peptidases (EC 3.4.11-19) and those of the endo-peptidases (EC 3.4.21-24, 3.4.99). Endo-peptidases cleave peptide bonds in the inner regions of the peptide chain, away from the termini. Exo-peptidases cleave only residues from the ends of the peptide chain. The exo-peptidases acting at the free N-terminus may liberate a single amino acid residue, a dipeptide or a tripeptide and are called respectively amino peptidases (EC 3.4.11), dipeptidyl peptidases (EC 3.4.14) and tripeptidyl peptidase (EC 3.3.14). Proteases starting peptide processing from the carboxyl terminus liberating a single amino acid are called carboxy peptidase (EC 3.4.16-18). Peptidyl-dipeptidases (EC 3.4.15) remove a dipeptide from the carboxyl terminus. Exo- and endo-peptidase in one are the dipeptidases (EC 3.4.13), which cleave specifically only dipeptides in their two amino acid halves. Omega peptidases (EC 3.4.19) remove terminal residues that are either substituted, cyclic, or linked by isopeptide bonds

Apart from the position where the protease cleaves a peptide chain, for each type of protease a further division is possible based on the nature of the preferred amino acid residues in the substrate. In general one can distinguish proteases with broad, medium and narrow specificity. Some proteases are simply named after the specific proteins or polypeptides that they hydrolyze, e.g. keratinase, collagenase, elastase. A narrow specificity may pin down to one particular amino acid or one particular sequence which is removed or which is cleaved respectively. When the protease shows a particular preference for one aminoacid in the P1 or P1′ position the name of this amino acid may be a qualifier. For example prolyl amino peptidase removes proline from the amino terminus of a peptide (proline is the P1 residue). X-Pro or proline is used when the bond on the amino side of the proline is cleaved (proline is P1′ residue), eg proline carboxypeptidase removes proline from the carboxyl terminus. Prolyl endopeptidase (or Pro-X) cleaves behind proline while proline endopeptidase (X-Pro) cleaves in front of a proline. Amino acid residue in front of the scissile peptide bond refers to the amino acid residue that contributes the carboxyl group to the peptide bond. The amino acids residue behind the scissile peptide bond refers to the amino acid residue that contributes the amino group to the peptide bond. According to the general convention an amino acid chain runs from amino terminus (the start) to the carboxyl terminus (the end) and is numbered accordingly. Endo proteases may also show clear preference for a particular amino acid in the P1 or P1′position, e.g. glycyl endopeptidase, peptidyl-lysine endopeptidase, glutamyl endopeptidase. In addition proteases may show a preference for a certain group of amino acids that share a certain resemblance. Such a group of preferred amino acids may comprise the hydrophobic amino acids, only the bulky hydrophobic amino acids, small hydrophobic, or just small amino acids, large positively charged amino acids, etc, etc. Apart from preferences for P1 and P1′ residues also particular preferences or exclusions may exist for residues preferred by other subsites on the protease. Such multiple preferences can result in proteases that are very specific for only those sequences that satisfy multiple binding requirements at the same time. In general it should be realized that protease are rather promiscuous enzymes. Even very specific protease may cleave peptides that do not comply with the generally observed preference of the protease. In addition it should be realized that environmental conditions such as pH, temperature, ionic strength, water activity, presence of solvents, presence of competing substrates or inhibitors may influence the preferences of the proteases. Environmental condition may not only influence the protease but also influence the way the proteinacious substrate is presented to the protease.

Proteases can be subdivided on the basis of their catalytic mechanism. It should be understood that for each catalytic mechanism the above classification based on specificity leads to further subdivision for each type of mechanism. Four major classes of proteases are known and are designated by the principal functional group in the active site: the serine proteases (EC 3.4.21 endo peptidase, EC 3.4.16 carboxy peptidase), the thiol or cysteine proteases (EC 3.4.22 endo peptidase, EC 3.4.18 carboxy peptidase), the carboxyl or aspartic proteases (EC 3.4.23 endo peptidase) and metallo proteases (EC 3.4.24 endo peptidase, EC 3.4.18 carboxy peptidase). There are characteristic inhibitors of the members of each catalytic type of protease. These small inhibitors irreversibly modify an amino acid residue of the protease active site. For example, the serine protease are inactivated by Phenyl Methane Sulfonyl Fluoride (PMSF) and Diisopropyl Fluoro Phosphate (DFP), which react with the active Serine whereas the chloromethylketone derivatives react with the Histidine of the catalytic triad. Phosphoramidon and 1,10 Phenanthroline typically inhibit metallo proteases. Inhibition by Pepstatin generally indicates an aspartic protease. E64 inhibits thiol protease specifically. Amastatin and Bestatin inhibit various aminopeptidases. Substantial variations in susceptibility of the proteases to the inhibitors are observed, even within one catalytic class. To a certain extent this might be related to the specificity of the protease. In case binding site architecture prevents a mechanism based inhibitor to approach the catalytic site, then such a protease escapes from inhibition and identification of the type of mechanism based on inhibition is prohibited. Chymostation for example is a potent inhibitor for serine protease with chymotrypsin like specificity, Elastatinal inhibits elastase like serine proteases and does not react with trypsin or chymostrypsin, 4 amido PMSF (APMSF) inhibits only serine proteases with trypsin like specificity. Extensive accounts of the use of inhibitors in the classification of proteases include Barret and Salvesen, Proteinase Inhibitors, Elsevier Amstardam, 1986; Bond and Beynon (eds), Proteolytic Enzymes, A Practical Approach, IRL Press, Oxford, 1989; Methods in Enzymology, eds E. J. Barret, volume 244, 1994 and volume 248, 1995; E. Shaw, Cysteinyl proteinases and their selective inactivation, Adv Enzymol. 63:271-347 (1990)

The catalytic mechanism of a proteases and the requirement for its conformational integrity determine mainly the conditions under which the protease can be utilized. Finding the protease that performs optimal under application conditions is a major challenge. Often conditions at which proteases have to perform are not optimal and do represent a compromise between the ideal conditions for a particular application and the conditions which would suit the protease best. Apart from the particular properties of the protease it should be realized that also the presentation of a proteinacious substrates is dependant on the conditions, and as such determines also which conditions are most effective for proteolysis. Specifications for the enzyme that are relevant for application comprise for example the pH dependence, the temperature dependence, sensitivity for or the dependence of metal ions, ionic strength, salt concentration, solvent compatibility. Another factor of major importance is the specific activity of a protease. The higher the enzyme's specific activity, the less enzyme is needed for a specific conversion. Lower enzyme requirements imply lower costs and lower protein contamination levels.

The pH is a major parameter that determines protease performance in an application. Therefore pH dependence is an important parameter to group proteases. The major groups that are recognized are the acid proteases, the neutral proteases, the alkaline proteases and the high alkaline proteases. The optimum pH matches only to some extent the proteolytic mechanism, e.g. aspartic protease show often an optimum at acidic pH, metalloproteases and thiol proteases often perform optimal around neutral pH to slightly alkaline, serine peptidases are mainly active in the alkaline and high alkaline region. For each class exceptions are known. In addition the overall water activity of the system plays a role. The pH optimum of a protease is defined as the pH range where the protease exhibits an optimal hydrolysis rate for the majority of its substrates in a particular environment under particular conditions. This range can be narrow, e.g. one pH unit, as well as quite broad, 3-4 pH units. In general the pH optimum is also dependant on the nature of the proteinacious substrate. Both the turnover rate as well as the specificity may vary as a function of pH. For a certain efficacy it can be desirable to use the protease far from its pH optimum because production of less desired peptides is avoided. Less desired peptides might be for example very short peptides or peptides causing a bitter taste. In addition a more narrow specificity can be a reason to choose conditions that deviate from optimal conditions with respect to turnover rate. Dependant on the pH the specificity may be narrow, e.g. only cleaving the peptide chain in one particular position or before or after one particular amino acid, or broader, e.g. cleaving a chain at multiple positions or cleaving before or after more different types of amino acids. In fact the pH dependence might be an important tool to regulate the proteolytic activity in an application. In case the pH shifts during the process the proteolysis might cease spontaneously without the need for further treatment to inactivate the protease. In some cases the proteolysis itself may be the driver of the pH shift.

In applications where low temperatures are required protease may be selected with emphasis on a high intrinsic activity at low to moderate temperature. As under such conditions inactivation is relatively slow, under these conditions activity might largely determine productivity. In processes where only during a short period protease activity is required, the stability of the protease might be used as a switch to turn the protease off. In such case more labile instead of very thermostable protease might be preferred.

Other environmental parameters which may play a role in selecting the appropriate protease may be its sensitivity to salts. The compatibility with metal ions which are found frequently at low concentrations in various natural materials can be crucial for certain applications. In particular with metallo proteases certain ions may replace the catalytic metal ion and reduce or even abolish activity completely. In some applications metal ions have to be added on purpose in order to prevent the washout of the metal ions coordinated to the protease. It is well known that for the sake of enzyme stability and life-time, calcium ions have to be supplied in order to prevent dissociation of protein bound calcium.

A comprehensive review on the biological properties and evolution of proteases has been published in van den Hombergh: Thesis Landbouwuniversiteit Wageningen: An analysis of the proteolytic system in Aspergillus in order to improve protein production ISBN 90-5485-545-2, which is hereby incorporated by reference herein.

### Phospholipase Treatment of the Cheese Milk

The cheese milk to be treated with phospholipase in the process of the present invention may comprise one or more of the following milk fractions: skim milk, cream, whole milk, buttermilk from production of sweet or acidified butter, whey protein concentrate, and butter or butter oil. The cheese milk to be treated with phospholipase by the process of the invention may also comprise raw milk. In further embodiments of the invention, the cheese milk to be treated by phospholipase is prepared totally or in part from dried milk fractions, such as whole milk powder, skim milk powder, casein, caseinate, total milk protein or buttermilk powder or any combination thereof. In the process of the invention the cheese may be produced from a milk based composition (the cheese milk), of which all or a portion has been subjected to a phospholipase treatment. The term ‘fraction of the cheese milk’ means the fracton of the cheese milk which is subjected to the phospholipase treatment. The fraction of the cheese milk may comprise one or more of the milk fractions as defined herein, e.g. skim milk, cream, whole milk, buttermilk from the production of sweet or acid butter, whey protein concentrate, butter and butter oil. The butter may, e.g. be in a melted form. The fraction of the cheese milk to be treated may also comprise raw milk and it may also be prepared from dried milk fractions as described herein. When a fraction of the cheese milk is phospho-lipase treated in step (2), than step (2) is performed before step (1) and not at another stage of the process of the invention. After the phospholipase treatment of the fraction of the cheese milk, the fraction is combined with one or more milk fractions to make the cheese milk from which the cheese is prepared.

So in general a fraction of the milk composition which is treated with a phospholipase means that between 30 to 100 v/v % of the total milk composition is treated with a phopholipase, preferably 50 to 100 v/v % of the total milk composition is treated with a phopholipase, more preferably 70 to 100 v/v % of the total milk composition is treated with a phopholipase and most preferably 80 to 100 v/v % of the total milk composition is treated with a phopholipase.

The phospholipase treatment in step (2) may be performed with a fraction of the cheese milk or it may be performed with the cheese milk as such. Thus, within the scope of the invention is a process for producing cheese which comprises the steps of a) treating a fraction of the cheese milk with a phospholipase; b) preparing cheese milk from the treated fraction; c) heat treating the cheese milk; d) addition of a protein hydrolysate and e) producing cheese from thus treated cheese milk. It is contemplated that in step b) the phospholipase treated cheese milk fraction can be combined with a non-phospholipase and/or a phospholipase treated cheese milk fraction to provide the cheese milk from which the cheese is finally produced in step (6) of the process of the invention.

In preferred embodiments, the cheese milk or the cheese milk fraction which is to be treated comprises or consists of cream. In further embodiments the cheese milk of the fraction of the cheese milk which is to be phopholipase-treated comprises or consists of butter oil. In still further embodiments the cheese milk of the fraction of the cheese milk which is to be phopholipase-treated comprises or consists of buttermilk. The process of the invention does not include a particular step for lowering the total fat content of the cheese.

The cheese milk, including the cheese milk fraction, to be treated with the phospholipase comprises phospholipids such as lecithin. The cheese milk may have any total fat content which is found suitable for the cheese to be produced by the process of the invention. Fat content in dry matter may be for example in the range of 10-50% fat, for example about 25% fat. Of the total fat in the range of 0.02%-5% (w/w) may be phospholipids, for example about 0.8% is phospholipids.

The process of the invention may further comprise a step of subjecting the treated cheese milk or the cheese milk fraction to a heating treatment after step (2), such as pasteurization.

In the process of the invention, the cheese milk or the fraction of the cheese milk may be subjected to a homogenization process before the production of cheese. The homogenization may be applied before and/or after the treatment with the phospholipase.

The phospholipase treatment may be conducted by dispersing the enzyme into the cheese milk or a fraction of the cheese milk, and allowing the enzyme reaction to take place at an appropriate holding time and appropriate temperature. The treatment may be carried out at conditions chosen to suit the selected enzymes according to principles well known in the art.

The enzymatic treatment may be carried our at any suitable pH, such as e.g. in the range 2 to 10, such as at a pH of 4 to 9 or 5 to 7. It may be preferred to use a pH of 5.5 to 7.0. The phospholipase treatment may be conducted on the cheese milk or a fraction of the cheese milk during cold storage at 3 to 7° C. for e.g. at east 2 hours, e.g. in the range of 2 to 48 hours. The treatment may also be conducted so that the phospholipase is allowed t react at coagulation conditions of 30 to 45° C. during the cheese making process in step (6). Further, the process may be conducted so that before coagulation of the cheese milk, the phospholipase is allowed to react on a milk fraction, e.g. cream, at the temperature optimum for the phospholipase, e.g. at 45-80° C., such as 47-80° C., or 50-80° C., e.g. for at least 10 minutes, such as at least 30 minutes, e.g. in the range of 10-180 minutes. Optionally after the enzymatic treatment the phospholipase enzymes removed and/or the enzyme is inactivated.

A suitable enzyme dosage will usually be in the range of 0.01-1% (w/w) of the fat content, such as e.g. 0.1-1.0%, particularly 0.2% (w/w) corresponding to 2000 IU per 100 g fat. On e IU is defined as the amount of enzyme producing a micro mole of free fatty acid per minute under standard conditions: egg yolk substrate (approximately 0.4% phospholipids), pH8, 40° C., 6 mM Ca²⁺).

Enzymes to be used in the process of the invention include phospholipase, such as phospholipase A1 (EC 3.1.1.32), phospholipase A2 (EC 3.1.1.4) and phospholipase B (3.1.1.5). In the process of the invention the phospholipase treatment may be provided by one or more phospholipases. Any combination of phospholipases is allowed; alternatively phospholipases may be used individually in the process of the invention. The phospholipases may be of any origin, e.g. of animal origin (such as e.g. mammalian), e.g. from pancreas (e.g. bovine or porcine pancreas), or snake venom of bee venom. Alternatievly the phospholipase may be of microbial origins e.g. from filamentous fungi, yeast or bacteria, such as the genus Aspergillus, e.g. A. niger, A. awamori, A foetidus, A japonicus, A oryzae, Dictyostelium, Mucor, e.g. M japonicus, M mucedo, M subtilissimus, Neurospora, e.g. N crassa, Rhizomucor, e.g. R pussilus, Rhizopus, e.g. R arrhizus, R japonicus, R stolonifer, Sclerotinia, e.g. S libertiana, Trichophyton, e.g. T rubrum, Whetzelinia, e.g. W sclerotium, Bacillus, e.g. B megaterium, B subtilis, citrobacter, e.g. C freundii, Enterobacter, e.g. E aerogenes, E cloacae Edwardsiella. E tarda, Erwinia, E herbicola, Escherichia, e.g. E coli, Klebsiella, e.g. K pneumoniae, Proteus, e.g. P vulgaris, Providencia, e.g. P stuartii, Salmonella, e.g. S typhimurium, Serratia, e.g. S liquefasciens, S marcescens, Shigella, e.g. S flexneri, Streptomyces, e.g. S violeceoruber, Yersinia, e.g. Y enterocolitica. Thus the phospholipase may be funga, e.g. from the class of Pyrenomycetes, such as the genus Fusarium, such as the strain F. culmorum, F heretosporum, F solani, F.graminearum, F. venenatum or a strain of F oxysporum.

The phospholipase used in the process of the invention may be derived or obtainable from any of the sources mentioned herein. The term ‘derived’ means in this context that the enzyme may have been isolated from an organism where it is present natively, i.e. the identity of the amino acid sequence of the enzyme is identical to a native enzyme. The term ‘derived’ also means that the enzymes may have been produced recombinantly in a host organism, the recombinant enzyme having either an identity identical to a native enzyme or having a modified amino acid sequence, e.g. having one or more amino acids deleted, inserted or substituted. Within the meaning of a native enzyme are included natural variants. Furthermore, the term ‘derived’ also includes enzymes produced synthetically by e.g. peptide synthesis and enzymes which have been modified e.g. by glycosylation or phosphorylation etc.

The phospholipase may be obtained from a microorganism by use of any suitable technique. For instance, a phospholipase enzyme may be obtained by fermentation of a suitable microorganism and subsequent isolation of phospholipase preparation from the resulting fermented broth or microorganism y methods known in the art. Suitable phospholipases are available commercially, e.g. Lecitase (Novozymes). In a further embodiment, the source of the lipase in the process of the invention is from expressing the enzyme by the started organism used in the production of cheese. The popsholipase used in the process of the invention may also be a purified pospholipase, referring to enzyme preparations where part of the non-phospholipase enzymes have been removed or reduced in concentration by methods known in the art. Preferably the enzymes are substantially pure, such as at least 75% (w/w) pure, more preferably at east 80%, 85, 90 or even at least 95% pure.

### Formagraph

The “Formagraph” is an instrument designed to record coagulation properties of cheese milk. Its use as a tool to compare rennet solutions has been described (MacMahon & Brown, J Dairy Sci (1982) 65, 1639-1642). The Formagraph measurements allow the determination of three parameters during cheese making as detailed by McMahon & Brown. These are r: milk coagulation time, the time required to start gel formation, k₂₀: curd-firming time, the time between start of gel formation until a width of 20 mm is reached and a₃₀: curd firmness, the width of the graph 30 min after enzyme addition. The k₂₀ equates with a curd firmness, adequate for cutting of cheese curd. The Formagraph model 11700 (Foss Electric, Benelux) was used in the examples described below, using 87% glycerol as damper liquid. The r and k₂₀ times are expressed in mm, as measured on the recorder paper. A distance of 1 mm corresponds with a time period of 30 seconds.

### EXAMPLES

### Example 1

### Effect of Yeast Extract and Phospholipase on the Cheese Yield from Milk Containing High Heated Milk

Mozzarella was prepared at 1 L scale, using the following protocol. 1 liter of pasteurized full fat cows milk was heated to 34° C. In some cases, mixtures of pasteurized and high heated milk were used, in which the volume percentage of high heated milk varied from 10%, 20%, 30%, 40%, 50% up to 100%. Next, 176 microliters Delvotec TS10/L (starter culture, DSM, The Netherlands) were added and the milk was gently stirred for 1 hour at 34° C. After this hour, optionally, the yeast extract and the phospholipase was added, followed by another 10 minutes of stirring. Coagulation was initiated by addition of 80 microliters Fromase 750 XLG (DSM, The Netherlands). After 45 minutes the curd was cut during 60 seconds and left for another 15 minutes. Then the temperature was raised to 41° C. under gentle stirring until the pH had dropped to pH6.2. Whey was separated from the curd, and the curd was double-folded on itself. The wet curd was turned every 15 minutes until the pH reached 5.2-5.4. The curd was subsequently cut into straps and salt was added (to 3% w/v) and mixed with the curd. Hot water (78° C.) was than added and the curd was kneaded for 3 minutes after which it was cooled in ice. Finally, the kneaded curd was weighed.

In the current experiment three experimental configurations were compared. In all cases, milk was used that contained 30% high heated milk (80° C., 10 minutes). The first set-up is the control in which no additions were done to the cheese milk and mozzarella cheese was prepared as described above. In the second set-up, 0.1% (w/v) Gistex LS (DSM, The Netherlands) were added to the cheese milk, followed by mozzarella making as described. In the third set-up, 0.1% Gistex LS and 0.2% Yield-Max (a phospholipase preparation obtained from Christian Hansen, Denmark) were added and Mozzarella cheese was prepared as described. When Gistex LS was included, the amount of starter culture that was added was reduced to 20% to prevent too fast acidification. A reduction to 20% of the regular doses of starter culture in the presence of 0.1% Gistex LS leads to an acidification rate that is very similar to the acidification measured in absence of Gistex LS. The experiment was repeated twice. The mass of the cheeses produced are given in the table below giving curd yield, curd dry matter, cheese yield and relative cheese yield (relative to control). Loss indicates weight loss of curd due to

| | | | | | Relative |
|---|---|---|---|---|---|
| | Curd yield | | Cheese yield | | yield |
| | gram | % | Gram | % | % |
| Set-up 1 | 114.59 | 11.44 | 109.12 | 10.90 | 100.0 |
| Control | | | | | |
| Set-up 2 + YE | 127.29 | 12.68 | 117.81 | 11.74 | 107.7 |
| Set-up 3 + YE and PL | 131.32 | 13.13 | 120.66 | 12.06 | 110.6 |

The data in the table above clearly show that addition of yeast extract leads to a yield increase, which is further increased by the addition of phospholipase.

1. A method of producing curd or cheese from a milk composition comprising the following steps:
(1) heat-treating the milk composition;
(2) treating the milk composition or a fraction thereof with a phospholipase;
(3) adding protein hydrolysate, preferably yeast extract, to the heat-treated milk composition before or after the heat treatment;
(4) coagulating the heat treated milk to form a gel;
(5) processing the formed gel into a curd and separating the whey from the curd; and
(6) optionally making cheese from the curd.

2. A method according to claim 1 whereby the protein hydrolysate, preferably yeast extract, is added after heat-treating the milk composition.

3. A method according to claim 1 whereby step (2) treating the milk composition or a fraction thereof with a phospholipase is done
before or after step (1) heat-treating the milk composition or
before or after step (3) adding protein hydrolysate, preferably yeast extract, to the heat-treated milk composition or
during step 4 coagulating the heat treated milk to form a gel or
during step 5 processing the formed gel into a curd.

4. A method according to claim 1 whereby the heat treatment causes whey denaturation of at least 30%.

5. A method according to claim 1 wherein the coagulation is an enzymatic coagulation.

6. A method according to claim 1 in which the protein hydrolysate, preferably yeast extract, is fortified by addition of a carboxylic acid at levels of 1-10% (w/w) dry weight, preferably 5-10% (w/w), more preferably 7-9% (w/w).

7. A method of producing curd according to claim 6 in which the carboxylic acid is malic acid or acetate.

8. A curd which is obtainable from the method according to claim 1.

9. A cheese which is produced from the curd of claim 8.

10. A dairy product which comprises curd of claim 8.

11. Use of phospholipase in combination with yeast extract to increase yield of a curd or a cheese in a cheese making process whereby heat-treated milk is used.

12. Use of a phospholipase in combination with yeast extract in producing a cheese prepared from heat-treated milk.

13. Use of a phospholipase in combination with yeast extract to produce a dairy product prepared from heat-treated milk.

14. Use of phospholipase in combination with yeast extract to increase the amount of fat in cheese making starting from heat-treated milk.

15. Use of claim 11 wherein the protein hydrolysate, preferably yeast extract, is fortified preferably is fortified with carboxylic acid.
